(19) United States
(12) Patent Application Publication
(10) Pub. No.: US 2010/0285962 A1
(43) Pub. Date: Nov. 11, 2010

(54) BIODEGRADABLE, PLANT-BASED COVERING AND PREMIXTURE

(76) Inventors: Michael P. Hoffmann, Ithaca, NY (US); Anil N. Netravali, Ithaca, NY (US); Jun T. Kim, Ithaca, NY (US); Kumar Hanumanthaiah, Syracuse, NY (US); Jeffrey Gardner, Hector, NY (US); Senthil Lingamoorthy, Ithaca, NY (US)

Correspondence Address: MARJAMA MULDOON BLASIAK & SULLIVAN LLP, 250 SOUTH CLINTON STREET, SUITE 300, SYRACUSE, NY, 13202, US

(21) Appl. No.: 12/777,804

(22) Filed: May 11, 2010

Related U.S. Application Data
(60) Provisional application No. 61/176,997, filed on May 11, 2009.

(51) Int. Cl. A01N 37/00; A01N 63/00; A01P 3/00; A01P 21/00; A01P 13/00; A01P 1/00

(52) U.S. Cl. 504/142; 514/1.1; 424/93.1

(57) ABSTRACT

A biodegradable covering for erosion control, plant protection, and seed coating can comprise a porous matrix of a dried premixture. The premixture can comprise a plant-based protein product and a plant-based fiber product. The plant-based protein product can comprise a plant-based protein, and the plant-based fiber product can comprise a plant-based fiber. In one embodiment, a method of forming a biodegradable covering for erosion control is provided. The method can comprise mixing a biodegradable premixture, placing the biodegradable premixture in an applicator, and applying the biodegradable premixture. The biodegradable premixture can comprise a plant-derived protein product and a plant-derived fiber product.

### CROSS REFERENCE TO RELATED APPLICATIONS

This application claims the benefit of priority under U.S.C. 119(e) to U.S. Provisional Application No. 61,176,997, filed May 11, 2009 entitled “Biodegradable Soy-Based Fibers and Fibrous Structures”. The content of this application is incorporated herein by reference in its entirety.

### FIELD OF THE INVENTION

The invention relates generally to biodegradable products and specifically to plant-based biodegradable products applied to soil, agricultural products, or other vegetation for protection of the soil, agricultural products, or other vegetation.

### BACKGROUND OF THE INVENTION

Soil erosion is a multifaceted problem. The uncontrolled movement of soils by water or wind causes significant environmental and health threats. Sediment alone can be a pollutant and sediment can also carry additional pollutants, for instance, from brownfield sites. Water contamination through soil erosion limits the fresh water supply available for human needs, such as for drinking, agriculture, or other human consumption.

Furthermore, soil erosion can degrade the fertility of the soil and be problematic and costly to agricultural and urban landscaping endeavors. Organic nutrients can be leached from the soil and/or washed away as the soil erodes, particularly on steep slopes, in places where little vegetative cover exists, and/or in places where heavy machinery is involved in land preparation or land disturbance (e.g. construction, landscaping, etc.). The protection of fertile land from soil erosion is increasingly important as cultivatable land decreases, consumer demand for food increases, and/or urbanization increases.

Addressing soil erosion is an endeavor that often relates to, or overlaps with, the protection of agricultural products (e.g. seeds and seedlings), vegetative cover (e.g. seeds and seedlings), and soil remediation. Eroded soils, being low in nutrients, provide reduced adequacy for the successful growth of agricultural products. Seeds and seedlings, which can act to stabilize soil, can be washed or swept away along with eroded soil, if not provided adequate cover.

A multitude of methods for erosion control are currently used. Methods that can be used include the use of some form of covering. Coverings include mats, nettings, mulches, hydromulches, and natural and synthetic geotextiles. The coverings can be applied over the soil to stabilize the soil, or the coverings can be applied over vegetation and/or agricultural, horticultural, and forestry products to act as a barrier against weathering and/or eroding elements like rain, sleet, wind, and excessive ultra violet rays, or against pests, insects, or other harmful elements.

Each of these covering methods suffers from significant shortcomings Many mats, nettings, mulches, hydromulches, and geotextiles, for example, are comprised of synthetic material derived from petroleum. These synthetic materials are non-biodegradable, and do not degrade for several decades after their useful lifespan. When these synthetics do degrade, they release pollutants into the soil and environment. Some synthetic mats and geotextiles that are rolled out to cover an area can be physically removed in order to avoid the immediate contamination of areas by waste, and later contamination of the areas by degrading pollutants. However, removal is an extra monetary cost, and often the synthetic mats and geotextiles can not be removed. Typically being woven, nonwoven (e.g. spunbonded), or otherwise porous, vegetation becomes entangled as the vegetation grows. The entanglement makes it difficult or impossible to remove the synthetic coverings. The mats and geotextiles are expensive, as well as the labor applying and attempting to remove to the mats and geotextiles. Such synthetic mats/materials have also proven dangerous to wildlife by entangling the wildlife or harming the wildlife when the wildlife eats the synthetic mats/materials along with the vegetation.

Natural mulches, hydromulches, and other natural coverings or otherwise biodegradable coverings, suffer from other shortcomings Some mulches include wood chips, grass clippings, leaves, and hay. Hydromulches typically are either a fibrous mulch or a mixture of fibrous mulch and seeds that are used to sow seed on the soil and stabilize the seeds on the soil and/or retain water to promote germination of the seeds. Some mulches and hydromulches, such as wood chips or newspaper shavings, are not versatile and can only practically be used to cover soil directly. Some mulches and hydromulches, which can be slurries, solutions, or solid dry ingredients, can be sprayed, splattered, or splayed to cover soil or vegetation. In either case, the mulches and hydromulches are weak relative to geotextiles, and more susceptible to mechanical damage and loss of functionality, particularly when applied to an incline. The mulches and hydromulches have little or no binding agent to bind the ingredients into a single, cross-linked, bound matrix. The individual or loosely connected components are relatively easily swept away by rain, wind, traffic, and other forces. Structural degradation can occur too quickly, and the strength and durability of the natural coverings is inadequate, for example, to stabilize the soil surface for sufficient time to allow seedling establishment.

Synthetic mulches and geotextiles release little or no plant nutrients as they degrade, and natural or otherwise biodegradable mulches, particularly those based on cellulose, release no enhanced, concentrated, or added plant nutrients as the natural or otherwise biodegradable mulches degrade.

It would be advantageous to use coverings for erosion control, soil stabilization, and soil enhancement, amongst other applications, that do not take several decades to degrade, and that do not pollute the environment as a result of degradation.

### SUMMARY OF THE INVENTION

In one embodiment, a biodegradable product for erosion control, plant protection, and seed coating is provided. The biodegradable product can comprise a plant-based protein product comprising a plant-based protein, and a plant-based fiber product comprising a plant-based fiber.

In one embodiment, a biodegradable covering for erosion control, plant protection, and seed coating is provided. The biodegradable covering can comprise a porous matrix of a dried premixture. The premixture can comprise a plant-based protein product and a plant-based fiber product.

In one embodiment, a method of forming a biodegradable covering is provided. The method can comprise mixing a biodegradable premixture, placing the biodegradable premixture in an applicator, and applying the biodegradable premixture. The biodegradable premixture can comprise a plant-derived protein product and a plant-derived fiber product.

### BRIEF DESCRIPTION OF THE DRAWINGS

FIG. 1 illustrates a biodegradable, plant-based, non-woven covering 10 applied as a premixture to a patch of soil, seeds, and plants, according to one embodiment of the invention.

FIG. 2 illustrates a covering 10 two weeks after application to a seed bed, the covering being applied through an applicator that can extrude premixture, according to one embodiment of the invention.

FIG. 3 illustrates a covering 10 applied through an applicator that can splatter, spray, or splay the premixture, according to one embodiment of the invention.

FIG. 4 illustrates a covering 10 applied as a film, according to one embodiment of the invention.

FIG. 5 illustrates the composition of the covering 10, as shown by the ingredients that can comprise the premixture, according to one embodiment of the invention.

FIG. 6 illustrates fibers of cellulose 30 at high magnification, according to one embodiment of the invention.

FIG. 7 is a chart illustrating the tensile stress of strands of covering, according to embodiments of the invention using canola, camelina, and sun flower, with 5% newspaper fibers and/or without the newspaper fibers.

FIG. 8 is a chart illustrating the Young's modulus of strands of covering, according to embodiments of the invention using canola, camelina, and sun flower, with 5% newspaper fibers and/or without the newspaper fibers.

FIG. 9 is a chart illustrating the tensile strain, in percentage, of strands of covering, according to embodiments of the invention using canola, camelina, and sun flower, with 5% newspaper fibers and/or without the newspaper fibers.

### DETAILED DESCRIPTION OF THE INVENTION

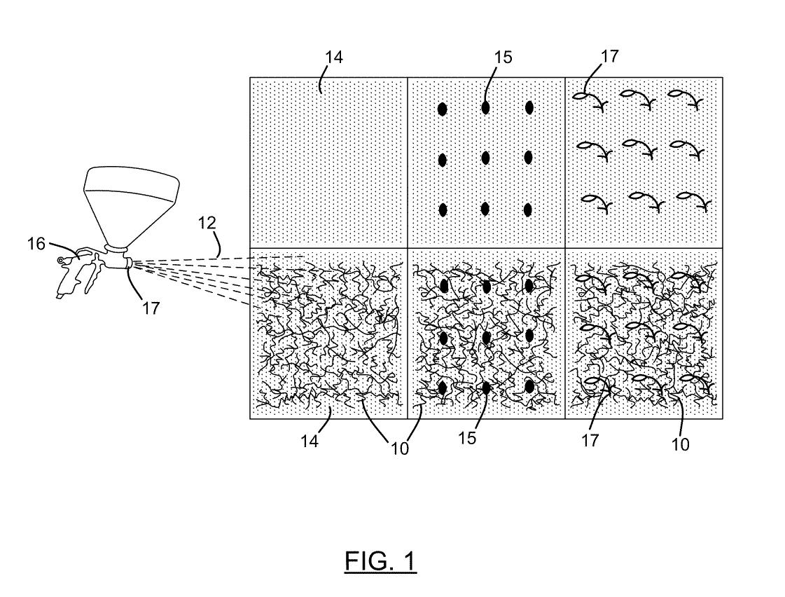

FIG. 1 illustrates a biodegradable, plant-based, non-woven covering 10 applied to a patch of soil 14, seeds 15, and plants 17, as a premixture 12 using a hand held applicator 16 with a nozzle 17, according to one embodiment of the invention. The biodegradable covering 10 and the premixture 12 are composed in a manner so that the natural decomposition of the biodegradable covering is facilitated and substantially completed within a desirable length of time after application. While many biodegradable materials decompose, the covering 10 of the present disclosure can be adjusted to decompose within various desirable ranges, and the covering 10 can be configured to simultaneously exhibit superior mechanical properties and increased capability, such as the ability to release plant nutrients during biodegradation, amongst others. Combinations of components can be mixed together as the premixture 12, which can be dry, or wet, but applied as a wet resin, a solution, a slurry, or a dough (e.g. by splattering, spraying, laying, splaying or extruding) to soil, vegetation, or agricultural products where it can dry to form the covering 10. The covering 10 may be thick or thin, and porous or non-porous, as desired. However, unlike synthetic materials used in conventional coverings, the composition of the present covering 10 is rendered biodegradable within a relatively short range of time after use (e.g. between 2 weeks and 8 months after application), rendered with sufficient mechanical strength, and rendered with water absorption or water repellant properties customizable for various lengths and types of use, and desired biodegration lengths.

The covering 10 can be applied as the premixture 12, wet, through splaying, spraying, laying, spattering, or extruding, and allowed to dry. The premixture 12 can dry to form the covering 10 in two hours or less time. Depending on the humidity and temperature, the covering 10 can dry in an hour or less time. The applicator 16 of FIG. 1 is a hand held sprayer, but an extruder or another variety of applicator 16 can also be used. The premixture 12 can be prepared with varying viscosities for use in different types of applicators 16, or applicators 16 with variously sized nozzles 17. For instance, a sprayer can use a lower viscosity premixture 12 than an extruder. Similarly, a smaller nozzle 17, such as a nozzle 17 with a diameter two millimeters, can use a lower viscosity premixture 12 than a larger nozzle 17, such as a nozzle 17 with a diameter eight millimeters. The applicator 16 can also be large relative to the hand held applicator 16, suitable, for example, to apply covering 10 to large fields. The applicator 16 can be a large industrial applicator, connectable to heavy equipment, for example, such as a tractor or other vehicle.

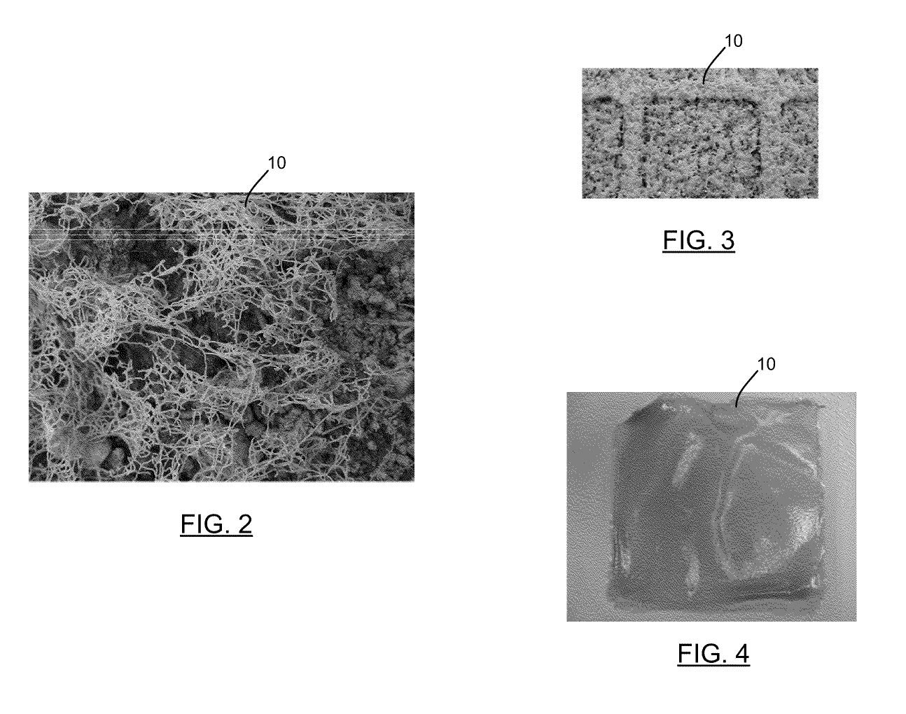

FIG. 2 illustrates a covering 10 two weeks after application to a seed bed, the covering 10 being applied through an applicator 16 that can extrude the premixture 12 in the form of resin or dough, according to one embodiment of the invention. FIG. 3 illustrates an alternate covering 10 applied through an applicator 16 that can spray or splay the premixture 12 in the form of a solution or slurry, according to one embodiment of the invention. FIG. 4 illustrates a covering 10 applied as a film, according to one embodiment of the invention. Discrete amounts of the premixture 12 can be formed during application that can mate with other discrete amounts of the premixture 12, which can bond during drying, leaving open and/or porous spaces 18 in the covering 10. The covering 10 can also be formed as a more uniform sheet or composite film. The discrete amounts of wet premixture 12 that can be formed during application can dry as uniform shapes or irregular shapes of various shape and size, depending in part on the size and shape of the nozzle 17. For instance, during extrusion, cylindrical or semi-cylindrical strands can be formed. Spraying can result in more irregular shapes. The porous spaces 18 can provide breathability, allowing vegetation more ease to grow through the covering 10. The porous spaces 18 can also allow interaction between the soil 14 and the atmosphere and natural elements.

The covering 10 can be useful for applications such as soil erosion control, soil stabilization, fertilization, seed germination, weed germination prevention, weed growth retardation or prevention, and vegetation and agricultural product protection. The covering 10 can additionally be used to deter pests and insects, kill pests and insects, stabilize seeds, and/or coat seeds. The plant-based covering 10 can be environmentally benign, fully sustainable, yearly renewable, fully biodegradable within less than a year under normal environmental conditions, and easily processed to offer an economically viable and environmentally friendly solution. Furthermore, during degradation, the plant-based covering 10 can add nutrients back into the soil 14.

The soil stabilization resulting from the use of the covering 10 can enable or enhance re-vegetation and phytoremediation, soil remediation mediated by plant growth. The selection of crops that do not translocate high concentrations of metals to edible parts, soils of brownfields, urban areas, and industrial areas provide a large-scale opportunity to use phytoremediation, phytostabilization, and monitored natural attenuation. There is a huge scope for cross-cutting other environmental agendas, with synergies that involve the recovery and provision of services from degraded landscapes and contaminated soils.

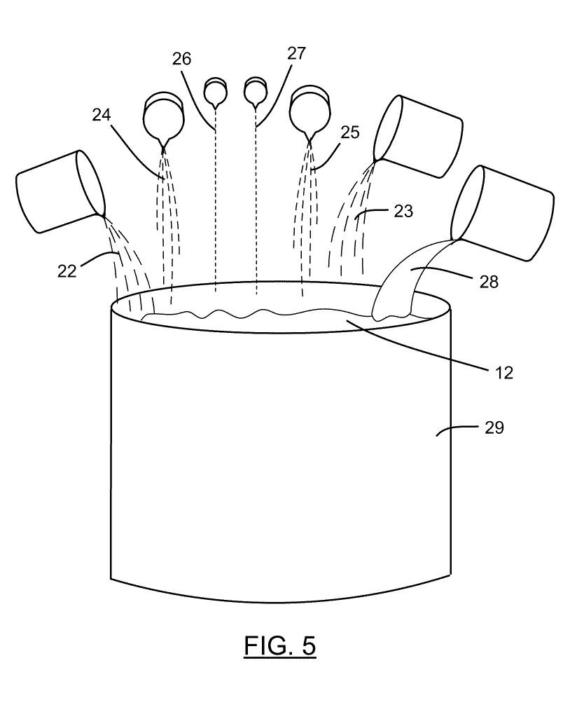

FIG. 5 illustrates the composition of the covering 10, as exemplified by the ingredients that can comprise the premixture 12. The premixture 12 and the covering 10 can comprise a plant-based protein 22, a plant-based fiber 23, a plasticizer 24, a cross-linking agent 25, other supplements 26, additives 27, and/or water 28.

The covering 10 can be comprised of a plant-based protein 22. The plant-based protein can be carried in protein-containing plant derivatives or plant-based protein products. The plant-based protein 22 can help provide structure to the covering 10, directly by binding and stabilizing fibrous materials in the composite premixture 12, and can also act as a natural fertilizer and nutrient, replenishing the soil when the covering 10 biodegrades. The plant based protein 22 in the covering 10 can be derived from a variety of plants, including but not limited to soy, sunflower, camelina, canola, and cotton. Soy, sunflower, camelina, canola, and cotton can be easily available, abundant, and relatively inexpensive. Soy-based examples of the protein-containing plant derivatives or plant-based protein products can include soy-protein concentrate (“SPC”), soy flours (“SF”), and/or soy-protein isolates (“SPI”). Other examples of protein-containing plant derivatives or plant-based protein products that can be used include corn flour, rice flour, wheat flour, whey, other flours, defatted canola, defatted camelina, defatted sunflower, and other seed-based meals or bean-based meals, or other natural derivatives containing a substantial amount of protein, such as but not limited to 20%. The form (e.g. from powder to pellets) can vary as well. For instance, meals or pellets can be used, and then ground into powder, or suspended or dissolved into suspensions or solutions.

The covering 10 can also comprise plant-based fibers 23. The fibers 23 can increase strength, thickness, and water absorbency of the covering 10. The fibers 23 can increase the tensile strength of the covering 10 by cross-linking or mechanically linking to other fibers 23. Strength depends in part on orienting polymer chains and reinforcing the fibers 23 linearly. Therefore, microfibrillated or nanofibrillated cellulose (MFC, NFC) can be used to further improve the tensile strength of the covering 10, as well as increase Young's Modulus. Being crystalline MFC and NFC can also increase the water resistance of the covering 10. During application of the premixture 12, the fibers 23 can be oriented as the fibers 23 exit the application tool 16. Increased tensile strength can increase durability of the covering 10 to withstand destructive elemental forces, which can increase the longevity of the covering 10.

Furthermore, the fibers 23 can increase the longevity of the covering 10 because the fibers 23 can degrade over a longer duration than the protein 22, such as five to six months. When the fibers 23 are used in the premixture 12 along with the protein 22, the protein 22 might degrade, leaving the fibers 23 holding together the covering 10, possibly for months before enough of the fibers 23 biologically or mechanically degrade to substantially render the covering 10 useless and/or substantially wash the covering 10 away.

The fibers 23 can also increase the thickness of the covering 10, which in turn, can increase the sturdiness and durability of the covering 10. Increased thickness and increased durability of the covering 10 can be useful for particular purposes. For instance, a thicker and/or more durable covering can enhance the ability of a covering 10 serving as a protective barrier to defend vegetation or seeds from pests, insects, or inclement weather. A thicker or less porous covering 10 can also be better suited to deter weed growth or other undesirable plant growth. The less porous covering 10 can have less pores, smaller pores, or no pores.

The fibers (e.g. shredded/recycled newspaper, jute, sisal, hemp, flax, etc.) 23 can also increase the moisture absorbency of the covering 10, which can be beneficial for certain purposes. For instance, the fibers 23 can retain water, which can help activate the germination of seeds or otherwise promote the growth of vegetation. At the same time, the fibers can exhibit excellent wicking capability, which can increase the length of time of biodegradation.

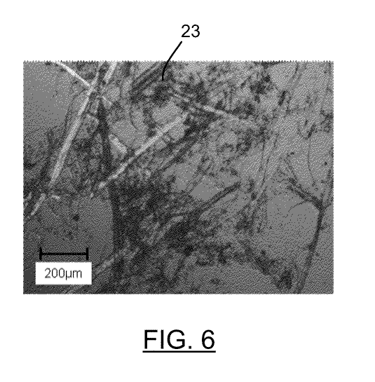

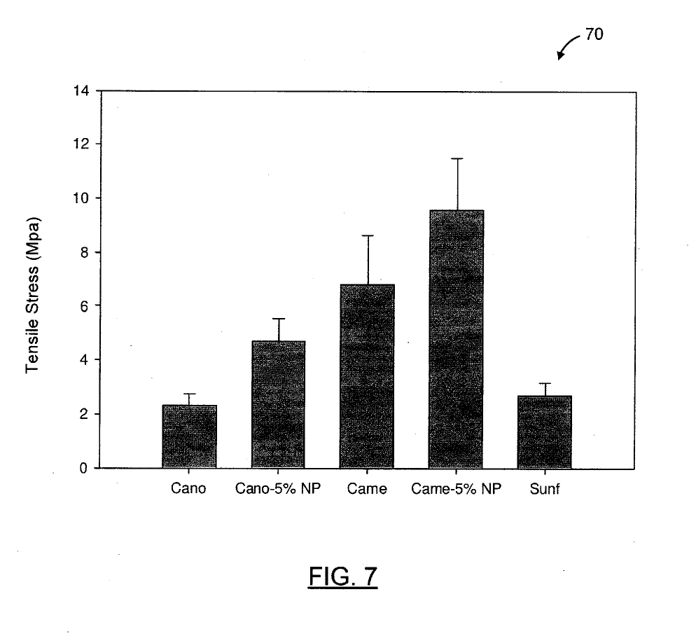

The fibers 23 can be contained in plant-based fiber products. Plant-based fiber products can include, but are not limited to, poly lactic acid filaments, recycled newspapers or other recycled paper products, recycled cotton products such as clothing, apparel, or bags, etc., jute, sisal, kenaf, hemp, and flax, amongst others. FIG. 6 illustrates fibers of cellulose 30 at high magnification. Cellulose 30 is a highly abundant biomass material available in nature. Cellulose 30 is also a linear molecule that plants organize into orientations that provide excellent mechanical properties and a low density. Cellulose 30 can be obtained from a large variety of sources. For example, a kraft or other wood-based pulp can be used. The pulp can be bleached without elemental chlorine or unbleached. Pulp fiber lengths can vary. In one embodiment, the average pulp fiber length can be between about 2.0 mm to about 2.6 mm The population of cellulose fibers 30 can also vary. In one embodiment, the population can range from about four million cellulose fibers 30 per gram to about seven million cellulose fibers 30 per gram.

The covering 10 can also comprise a plant-based plasticizer 24. Examples of the plasticizer 24 can include, but are not limited to glycerol, linseed oil (e.g. Linseed oil Toplin x-z (LST) grade and double boiled (LSDB)), canola oil, other vegetable oils, waste cooking oil, and gums, such as agar agar and guar gum. The plasticizer 24 can decrease Young's Modulus (i.e. increase elasticity) and tensile stress, and increase flexibility and tensile strain of the covering 10. Many of these unsaturated oils (e.g. fast drying linseed oil) undergo cross-linking and polymerization that improves the strength of the covering 10. Furthermore, oils act as water repellants, increasing the length of time of biodegradation. On the other hand, the presence of hydroxyl groups in glycerol, e.g., can also cause moisture absorption to increase. Agar agar and guar gum also can increase moisture content, increase the viscosity of the premixture 12, and thus the extrudability of the premixture 12.

The covering 10 can also comprise a cross-linking agent 25 such as glutaraldehyde or glyoxal. The cross-linking agent 25 can be plant-based, such as rutin and quercetin. The cross-linking agent 25 can increase the tensile strength of the protein 22. The cross-linking agent 25, such as rutin and quercetin, which are plant-based polyphenols, can be used to cross-link the plant-based proteins 22. In one method of cross-linking the plant-based proteins 22, rutin or quercetin solution can be prepared by dissolving equi-molar amounts of rutin or quercetin in a predetermined amount of distilled water and a one to one molar ratio of sodium hydroxide (NaOH). The rutin or quercetin solution can then be mixed with the premixture 12, such as can be composed, by example, of soy flour, glycerol at 5% the weight of the soy flour, and distilled water at 1500% the weight of the soy flour.

The covering 10 can also comprise other supplements 26. For example, clay and nanoclay can reduce water and increase durability, which can lengthen the biodegradation time. Also, surfactants such as p-tertiary-octylphenoxy polyethyl alcohol and other supplements 26 for modifying surface tension and retarding gelation can be included.

The covering 10 can also comprise additives 27 that can actively benefit the soil, crops, or agricultural products to which the covering 10 is applied, or assist in the preparation of the premixture 12. For instance, NaOH, gypsum, or other pH altering additives can adjust the pH of the covering 10 to a desired level specific to the application, crop, soil, or agricultural product. For example, one mole (M) of NaOH solution can be prepared by dissolving 4 grams of NaOH in 25 milliliters (mL) of water and then increasing the total volume of the solution to 100 mL by adding water. The addition of 1 M of NaOH solution can adjust the pH level, in one embodiment, upwards to 8.4, which can be suitable for a particular vegetation or soil. The higher pH also allows opening of the protein molecules which can ease film and fiber formation. The concentration and amount of NaOH or other additives can be varied as desired.

Another example of an additive includes a polyacrylate, which is a water absorbing agent with excellent water absorptive and retention properties that can enhance applications such as, for example, seed germination. The additives 27 can also include soil enhancers, fertilizers, pesticides, pest deterrents, seeds, bioremediation organisms, beneficial organisms (e.g. rhizobia, trichoderma, etc.), herbicides, fungicides, insecticides, plant growth regulators (e.g. auxins, cytokinins, etc.), and/or other natural or artificial chemicals that offer other functionalities. One functionality can be to change the pest behavior and/or reproductive capability. Generally, the additives 27 can comprise only a relatively low percentage of the total premixture 12 and/or covering 10. Some additives 27, though, such as seeds, can be a significant portion of the total premixture 12 and/or covering 10.

One or more of the plant-based proteins 22, the plant-based fibers 23, the plasticizers 24, the cross-linking agents 25, the other supplements 26, and the additives 27 can be added to and mixed into the premixture 12, depending on the particular application and characteristics desired for the application. Water 28 can also comprise the premixture 12. The premixture 12 and the covering 10 can contain a wide range in the percentage of the fiber 23, the protein 22, and the water 28. In some embodiments, the premixture 12 and covering 10 can contain up to 70% fiber 23. In some embodiments, the premixture 12 can contain up to 80% water 28, with the remaining 20% or more comprised of the protein 22, the fiber 23, and/or the plasticizer 24, the other supplements 26 and/or the additives 27. In at least one embodiment, the premixture 12 and/or the covering 10 is entirely “green”, meaning the composition, other than the water), is entirely plant-based, derived from plants, and biodegradable.

The premixture 12 can be stored as a dry mix, with the wet ingredients added at a desirable time before use and application. Water is a solvent, acting to dissolve, disperse, suspend, and allow uniform mixing of the premixture 12. Uniform mixing of the premixture 12 can add structural integrity, and evenly distribute the functional capabilities (e.g. stabilizing soil, fertilizing soil, etc.) of the covering 10 throughout the covering 10. At the desirable time, water 28 can be added to the premixture 12 for such mixing. Other wet ingredients, such as liquid plasticizers 24 and/or solutions can also be added at the desirable time. The premixture 12 can also be stored wet for a period of time before use.

In one example, the protein 22 used to create the premixture 12 can be contained in soy flour. The water 28 can be distilled, filtered, unfiltered, spring, or tap water. The water, (e.g. 230% by weight), can be added and stirred into the soy flour to create the premixture 12. The amount of water relative to the amount of soy flour can be adjusted to obtain the desired physical characteristics. The length and temperature at which the premixture 12 is stirred can also vary significantly to achieve the desired characteristics of the covering 10.

The covering 10 can biodegrade as microbes thrive and release destructive enzymes. Microbes that are responsible for biodegradation need water to thrive. Therefore, the length of biodegradation can be adjusted using various combinations of ingredients, and various percentages of the various ingredients that affect the water absorptive and/or water repellant properties of the covering 10, and hence, the ability for microbes to survive and cause biodegradation. For instance, increased fibers 23, and larger fibers 23 increase the water repellant properties of the covering 10 and increase the length of time before the covering 10 biodegrades. Bactericides can also be added to the premixture 12 to reduce or prevent the microbe growth responsible for biodegradation. The biodegradation range adjustment can depend upon the intended useful life of the covering, which can depend upon the application. For instance, if the covering 10 is intended to be sprayed on the seeds of a freshly planted crop to protect the seeds from erosion or other harmful elements, until the seeds establish sturdy roots, then the intended useful life of the covering can be a range of time slightly longer, minimally as long, or approximately as long as the expected length of time required for the seeds to establish the sufficient roots. If the covering 10 is intended to be sprayed with a grass seed additive on a portion of exposed, disturbed soil to control erosion, then the intended useful life of the covering can be a range of time sufficient to allow enough of the seeds to germinate and establish roots sufficient to limit soil erosion to acceptable levels. Generally, biodegradation can substantially degrade the covering 10 within six months.

For further clarification, instruction, and description of the concepts above, embodiments of the present invention are now illustrated and discussed in connection with the following examples and experimental results.

### Example I

Series of premixtures can be made combining soy flour with different amounts of water and linseed oil (e.g. LST and/or LSDB). The premixture can be extruded using a hand held extruder and can also be extruded and applied using a splatterer. The splatterer can comprise a hopper, a slurry pump, a hose, and an air compressor to deliver sufficient forced air to carry the slurry or premixture from the nozzle and to the target. Different apertures can be used, sized at, for example, 4 mm, 6.5 mm and 7 mm.

Soy flour can be added to a mixing container. Linseed oil (either LST/LSDB 10 and 25% by weight of SF) can be added slowly to the soy flour, along with water, using slow mixing at room temperature. When the flour is wet and starts to become a solid, doughy mass, the speed of mixing (e.g. kneading) can be increased to beat the lumps and make the premixture uniform. As the premixture becomes uniform, e.g. after 20 minutes, a remaining amount of water can be added slowly to make the premixture uniform. Mixing (e.g. kneading) can be continued, e.g. for another 25 minutes. A narrow clearance between a mixing blade and the steel container helps in beating and making the premixture free from grains. Industrial scale mixing can be accomplished, for example, with a cement mixer.

Approximately 100 grams of uniform premixture can be placed into a cylindrical barrel of a hand held extruder. The piston of the extruder can be pushed manually at laboratory temperature. As the premixture starts to come out at a constant rate then the strands of premixture can be made to pull at a constant rate on to a plate. Drawn strands of premixture can be allowed to dry at room temperature. In this example, the strands of premixture can start to harden in 25 minutes and dry in almost 60 minutes. A qualitative assessment of the feasibility of this process of making soy-based strands of fabric is expressed in Table 1 below, with the use of various percentages of water, linseed oil, and mixing times. Extrudability, fiber formation, and rain resistance for the variations of soy-based strands of fabric are indicated as feasible by a check mark, and not feasible by an “x”.

TABLE 1

| | | | Kneading | | | | Drying |
|---|---|---|---|---|---|---|---|
| | Water | Linseed | time | | Strand | Rain- | time |
| Ex. # | (%) | Oil (%) | (min) | Extrudability | formation | resistance | (min) |
| 1 | 200 | 0 | 90 | ✓ | ✓ | Not | |
| | | | | | | tested | |
| 2 | 50-90 | 0 | 90 | X | X | Not | |
| | | | | | | tested | |
| 3 | 100 | 0 | 90 | X | X | Not | |
| | | | | | | tested | |
| 4 | 120 | 0 | 90 | X | X | Not | |
| | | | | | | tested | |
| 5 | 145 | 0 | 90 | ✓ | ✓ | Not | |
| | | | | | | tested | |
| 6 | 140 | 10 | 60 | ✓ | ✓ | Not | |
| | | | | | | tested | |
| 7 | 105 | 25 | 90 | X | x | Not | |
| | | | | | | tested | |
| 8 | 105 | 40 | 90 | X | x | Not | 10 |
| | | | | | | tested | |
| 9 | 128 | 25 | 90 | ✓ | ✓ | Not | 20 |
| | | | | | | tested | |
| 9a | 128 | 25 | 60 | ✓ | ✓ | Not | 20 |
| | | | | | | tested | |
| 10 | 267 | 40 | 45 | ✓ | ✓ | 96 h ✓ | 70 |
| 11 | 267 | 40 | 45 | ✓ | ✓ | 96 h ✓ | 70 |
| 12 | 166 | 10 | 45 | ✓ | ✓ | Not | Not |
| | | | | | | tested | tested |
| 13 | 217 | 10 | 45 | ✓ | ✓ | 48 h ✓ | 70+ |
| 14 | 233 | 10 | 45 | ✓ | ✓ | 48 h ✓ | 70+ |

### Example II

Series of premixture can be made combining soy flour with water and linseed oil, and reinforced structurally using 5%, 7.5%, 10%, 12.5%, and 15% cellulose fiber. The premixture can be extruded using a hand held extruder and can also be splattered using a splattering gun. Different apertures can be used, sized at, for example, 4 mm, 6.5 mm and 7 mm.

The linseed oils used can be LST and LSDB. A high cellulose kraft pulp bleached without elemental chlorine, with an average cellulose fiber length of 2.5 mm and a population of 4.8 million cellulose fibers per gram, exhibiting excellent absorbency, wicking, and fluff pad integrity can be used. A second cellulose—a softwood kraft pulp—a blend of spruce and pine, can also be used. A high hemicelluloses content of the softwood kraft pulp delivers high tensile strength at reduced refining energy requirements. The average length of the softwood kraft pulp cellulose is 2.29 mm, with a population of 6.1 million cellulose fibers per gram.

To prepare the premixture, the soy flour, the cellulose and the linseed oil can be mixed in a container. Water can be slowly mixed as well. The mixture can be mixed until it becomes homogeneous and uniform. Mixing can take about 45 minutes.

The uniform premixture can be placed into an extruder and extruded. The piston of the extruder can be pushed manually at laboratory temperature. Drawn strands of premixture can be allowed to dry. The cellulose fibers can orient in the direction of extrusion to increase the strength of the fabric.

Tensile properties of wood pulp reinforced SF strands of fabric can be determined using 20 mm fiber reinforced strands by straining at a rate of 10%. The results of tensile properties, tensile strain properties, and Young's modulus properties are given in tables 2, 3, and 4, respectively. In one embodiment, the tensile strength and Young's modulus of SF strands of fabric increases with the increase in cellulose.

TABLE 2
Tensile stress of cellulose reinforced SF strands of covering

| Cellulose | Tensile stress (MPa) |
|---|---|
| loading (w/w) | Cellulose |
| 2.5 | 3.22 ± 1.3 |
| 5 | 5.72 ± 2 |
| 7.5 | 8.6 ± 2.7 |
| 10 | 12.6 ± 4.5 |
| 12.5 | 24.4 ± 5 |
| 15 | 16.34 ± 4.1 |

TABLE 3
Tensile strain of cellulose reinforced SF strands of covering

| | |
|---|---|
| Cellulose | Tensile strain (%) |

| loading (w/w) | Cellulose | MFC |
|---|---|---|
| 2.5 | 3.68 ± 1.7 | |
| 5 | 5.35 ± 1.3 | 5.49 ± 1.7 |
| 7.5 | 4.52 ± 1 | 5.36 ± 1.7 |
| 10 | 4.6 ± 2.33 | |
| 12.5 | 4.7 ± 0.98 | |
| 15 | 3.54 ± 1.0 | |

TABLE 4
Young's modulus of cellulose reinforced SF strands of covering

| Cellulose | Young's modulus |
|---|---|
| loading (w/w) | (MPa) Cellulose |
| 2.5 | 304 ± 136 |
| 5 | 326 ± 83 |
| 7.5 | 470 ± 146 |
| 10 | 694 ± 164 |
| 12.5 | 1309 ± 266 |
| 15 | 1224 ± 331 |

### Example III

Series of SF premixture can be made to be applied using a sprayer or splatterer. The premixture can contain 20%, 30%, and 40% cellulose pulp. Using the recipes given in table 5, table 6, and table 7, premixture can be prepared by mixing the soy flour, the linseed oil, and the cellulose fibers with 50% of the water, mixing slowly until the premixture becomes a homogeneous, sticky mass. Once the premixture becomes a homogeneous, sticky mass, the speed of mixing (e.g. kneading) can be increased to disperse the cellulose fibers thoroughly in the premixture. Midway through mixing (e.g. after about 22.5 minutes), water can be added slowly over 10 minutes while continuing stirring. The mixture can be stirred for a total time of 45 minutes.

TABLE 5
Recipe to make 20% cellulose reinforced SF containing 25% linseed oil
20% fiber

| | | Actual | | Weight % w/r/t |
|---|---|---|---|---|
| | | weight | | to total mass of |
| Sl. No. | Reagent | (g) | Weight % | the premixture |
| 1 | Soy flour | 160 | | 12.8 |
| | | | 20% of net weight | |
| 2 | Cellulose | 40 | of SF and cellulose | 3.2 |
| | Linseed oil - | | | |
| | Toplin x-z | | 25% w/r/t weight | |
| 3 | grade | 50 | of SF and cellulose | 4 |
| 4 | Water | 1000 | | 80 |

TABLE 6
Recipe to make 30% cellulose reinforced SF containing 25% linseed oil
30% fiber

| | | Actual | | Weight % w/r/t. |
|---|---|---|---|---|
| | | weight | | to total mass of |
| Sl. No. | Reagent | (g) | Weight % | the premixture |
| 1 | Soy flour | 140 | | 11.2 |
| | | | 20% of net weight | |
| 2 | Cellulose | 60 | of SF and cellulose | 4.8 |
| | Linseed oil - | | | |
| | Toplin x-z | | 25% w/r/t weight | |
| 3 | grade | 50 | of SF and cellulose | 4 |
| 4 | Water | 1000 | | 80 |

TABLE 7
Recipe to make 40% cellulose reinforced SF containing 25% linseed oil
40% fiber

| | | Actual | | Weight % w/r/t |
|---|---|---|---|---|
| | | weight | | to total mass of |
| Sl. No. | Reagent | (g) | Weight % | the premixture |
| 1 | Soy flour | 120 | | 9.6 |
| | | | 20% of net weight | |
| 2 | Cellulose | 80 | of SF and cellulose | 6.4 |
| | Linseed oil - | | | |
| | Toplin x-z | | 25% w/r/t weight | |
| 3 | grade | 50 | of SF and cellulose | 4 |
| 4 | Water | 1000 | | 80 |

The premixture can be placed in an applicator and sprayed or splattered on a sheet for testing and dried at room temperature, or splayed on soil and/or vegetation. While applying the premixture, a nozzle with an aperture 4.5 mm in diameter can be used for 20% fiber filled paste, a nozzle with an aperture 6 mm in diameter can be used for 30% filled premixture, and a nozzle with an aperture 7.5 mm in diameter can be used for 40% fiber filled premixture.

Using the same mixing and applying (e.g. spraying, splaying, or splattering) process, premixture recipes using linseed oil in an amount 10% of the weight of the soy flour can be made with various percentages of cellulose fiber, as indicated in tables 8-10.

TABLE 8
Recipe to make 20% cellulose reinforced SF containing 10% linseed oil
20% fiber

| | | Actual | | Weight % w/r/t |
|---|---|---|---|---|
| | | weight | | to total mass of |
| Sl. No. | Reagent | (g) | Weight % | the paste |
| 1 | Soy flour | 160 | | 13.1 |
| | | | 20% of net weight | |
| 2 | Cellulose | 40 | of SF and cellulose | 3.3 |
| | Linseed oil - | | | |
| | Toplin x-z | | 10% w/r/t weight | |
| 3 | grade | 20 | of SF and cellulose | 1.6 |
| 4 | Water | 1000 | | 82.0 |

TABLE 9
Recipe to make 30% cellulose reinforced SF containing 10% linseed oil
30% fiber

| | | Actual | | Weight % w/r/t |
|---|---|---|---|---|
| | | weight | | to total mass of |
| Sl. No. | Reagent | (g) | Weight % | the paste |
| 1 | Soy flour | 140 | | 11.5 |
| | | | 20% of net weight | |
| 2 | Cellulose | 60 | of SF and cellulose | 4.9 |
| | Linseed oil - | | | |
| | Toplin x-z | | 10% w/r/t weight | |
| 3 | grade | 20 | of SF and cellulose | 1.6 |
| 4 | Water | 1000 | | 82.0 |

TABLE 10
Recipe to make 40% cellulose reinforced SF containing 10% linseed oil
40% fiber

| | | Actual | | Weight % w/r/t |
|---|---|---|---|---|
| | | weight | | to total mass of |
| Sl. No. | Reagent | (g) | Weight % | the paste |
| 1 | Soy flour | 120 | | 9.8 |
| | | | 20% of net weight | |
| 2 | Cellulose | 80 | of SF and cellulose | 6.6 |
| | Linseed oil - | | | |
| | Toplin x-z | | 10% w/r/t weight | |
| 3 | grade | 20 | of SF and cellulose | 1.6 |
| 4 | Water | 1000 | | 82.0 |

### Example IV

Plant meals provided in pellet form can be ground into powder and sieved, if necessary, using a #50 (particle size 300 micrometers) and a sieve #60 (particle size 250 micrometers). Filtrates from the sieving process can be processed into films and fibers. Film can be prepared by dissolving plant meals in tap water and adding glycerol as a plasticizer to avoid the brittleness of the films. Solution pH can be controlled using 1 molar of NaOH solution. Newspaper can be shredded and blended to a fine slurry in water. This blended newspaper slurry can be mixed with the plant meal solution. This solution can be precured at 75 degrees Celsius in a water bath for 30 minutes. After precuring, the solution can be cast on a sheet and dried at 35 degrees Celsius in an air circulating oven for about 16 hours. Dried films can be cured (e.g. hot pressed) at 110 degrees Celsius for ten minutes under a pressure of four MPa. The cured films can be conditioned at 21 degrees Celsius and 65% relative humidity (RH) for three days prior to testing of the tensile properties.

Premixture to extrude strands of covering can be prepared by processing plant meals into plant meal powders and mixing the plant meal powders with water. The meals can become wet and begin to solidify into a doughy, uniform premixture. The premixture can then be extruded into strands using a hand held extruder. Tables 11 to 16 show the compositions and conditions of the films and strands made using canola, camelina, and sunflower meals.

TABLE 11
Compositions used for Canola films

| | Water | Glycerol | | Glutaraldehyde | Glyoxal | Newspaper | |
|---|---|---|---|---|---|---|---|
| Ex. # | (%) | (%) | pH | (%) | (%) | (%) | Note |
| Canola-01 | 1500 | 5 | 8 | — | — | — | |
| Canola-02 | 1500 | 5 | 10 | — | — | — | |
| Canola-03 | 1500 | 5 | 11 | | | | |
| Canola-04 | 1500 | 5 | 12 | — | — | — | |
| Canola-05 | 1500 | 7.5 | 12 | — | — | — | |
| Canola-06 | 1500 | 10 | 12 | — | — | — | |
| Canola-07 | 1500 | 15 | 12 | — | — | — | |
| Canola-08 | 1500 | 10 | 12 | 1 | — | — | |
| Canola-09 | 1500 | 10 | 12 | 5 | — | — | |
| Canola-10 | 1500 | 10 | 12 | 10 | — | — | |
| Canola-11 | 1500 | 10 | 12 | 20 | — | — | |
| Canola-12 | 1500 | 10 | 12 | 30 | — | — | |
| Canola-10 | 1500 | 10 | 12 | — | 1 | — | |
| Canola-11 | 1500 | 10 | 12 | — | 5 | — | |

TABLE 12
Compositions used for Camelina films

| | Water | Glycerol | | Glutaraldehyde | Glyoxal | Newspaper | |
|---|---|---|---|---|---|---|---|
| Ex. # | (%) | (%) | pH | (%) | (%) | (%) | Note |
| Camelina-01 | 2500 | 5 | 8 | — | — | — | |
| Camelina-02 | 2500 | 5 | 9 | — | — | — | |
| Camelina-03 | 2500 | 5 | 10 | — | — | — | |
| Camelina-04 | 2500 | 5 | 11 | — | — | — | |
| Camelina-05 | 2500 | 7.5 | 8 | — | — | — | |
| Camelina-06 | 2500 | 10 | 8 | — | — | — | |
| Camelina-07 | 2500 | 15 | 8 | — | — | — | |
| Camelina-08 | 2500 | 7.5 | 8 | 2.5 | — | — | |
| Camelina-09 | 2500 | 7.5 | 8 | 5 | — | — | |
| Camelina-10 | 2500 | 7.5 | 8 | 7.5 | — | — | |
| Camelina-11 | 2500 | 7.5 | 8 | 10 | — | — | |
| Camelina-12 | 2500 | 7.5 | 8 | — | 2.5 | — | |
| Camelina-13 | 2500 | 7.5 | 8 | — | 5 | — | |
| Camelina-14 | 2500 | 7.5 | 8 | — | 7.5 | — | |
| Camelina-15 | 2500 | 7.5 | 8 | — | 10 | — | |
| Camelina-16 | 2500 | 7.5 | 8 | — | — | 5 | |
| Camelina-17 | 2500 | 7.5 | 8 | — | — | 10 | |
| Camelina-18 | 2500 | 7.5 | 8 | — | — | 15 | |
| Camelina-19 | 2500 | 7.5 | 8 | — | — | 20 | |
| Camelina-20 | 2500 | 7.5 | 8 | — | — | 30 | |

TABLE 13
Compositions used for Sunflower films

| | Water | Glycerol | | Glutaraldehyde | Glyoxal | Newspaper | |
|---|---|---|---|---|---|---|---|
| Ex. # | (%) | (%) | pH | (%) | (%) | (%) | Note |
| Sunflower-01 | 2000 | 5 | 8 | — | — | — | |
| Sunflower-02 | 2000 | 5 | 10 | — | — | — | |
| Sunflower-03 | 2000 | 5 | 11 | — | — | — | |
| Sunflower-04 | 2000 | 5 | 12 | | | | |

TABLE 14
Compositions used for Canola fibers

| | Water | Linseed oil | Newspaper | |
|---|---|---|---|---|
| Ex. # | (%) | (%) | (%) | Note |
| Canola F-01 | 100 | — | — | |
| Canola F-02 | 100 | 10 | — | |
| Canola F-03 | 120 | 30 | — | |
| Canola F-04 | 120 | 30 | — | |
| Canola F-05 | 120 | — | — | |
| Canola F-06 | 120 | — | 5 | |

TABLE 15
Compositions used for Camelina fibers

| | Water | Linseed oil | Newspaper | |
|---|---|---|---|---|
| Ex. # | (%) | (%) | (%) | Note |
| Camelina F-01 | 180 | — | — | |
| Camelina F-02 | 180 | 15 | — | |
| Camelina F-03 | 180 | 15 | 5 (no grinding) | |
| Camelina F-04 | 180 | 15 | 5 | |
| Camelina F-05 | 180 | — | 5 | |

TABLE 16
Compositions used for Sunflower fibers

| | Water | Linseed oil | Newspaper | |
|---|---|---|---|---|
| Ex. # | (%) | (%) | (%) | Note |
| Sunflower F-01 | 110 | — | — | |
| Sunflower F-02 | 110 | — | 5 | |

Plant meal premixture can be made for spraying. Table 17 shows the compositions of premixture made for spraying. The premixture was made using soy flour (SF), and canola, camelina, and sunflower meals.

TABLE 17
Composition of spraying solutions

| Trial | |
|---|---|
| No | Composition of solutions |
| 1 | 100 g SF + 270 ml water |
| 2 | 100 g SF + 270 ml water + 5 g newspaper + 100 ml water |
| 3 | 100 g SF + 270 ml water + 10 g newspaper + 200 ml water |
| 4 | 100 g Canola + 300 ml water |
| 5 | 100 g Canola + 300 ml water + 5 g newspaper + 100 ml water |
| 6 | 100 g Canola + 300 ml water + 10 g newspaper + 200 ml water |
| 7 | 100 g Camelina + 450 ml water |
| 8 | 100 g Camelina + 450 ml water + 5 g newspaper + 100 ml water |
| 9 | 100 g Camelina + 450 ml water + 10 g newspaper + 200 ml water |
| 10 | 100 g Sunflower + 330 ml water |
| 11 | 100 g Sunflower + 330 ml water + 5 g newspaper + 100 ml water |
| 12 | 100 g Sunflower + 330 ml water + 10 g newspaper + 200 ml water |

### Example V

Tensile properties such as tensile (fracture) stress, tensile (fracture) strain and Young's modulus of canola, camelina, and sunflower films can be characterized. The effects of plasticizer (glycerol), pH, crosslinker (glutaraldehyde or glyoxal), and newspaper on the tensile properties of the films can be determined. Canola films can be prepared from a premixture with a pH level of approximately 12, which can be a suitable pH level to improve protein cross-linking and structural integrity of the canola films. At other pH levels, the films might not be uniform, and small holes can form in the covering. Camelina films can be prepared from a premixture at a pH level of approximately 8 which can show a relatively high tensile strength and stiffness compared to other premixtures. Sunflower films can be prepared from premixtures with various pH levels. Small holes might form in the covering, which can reduce the tensile properties and/or cause a high deviation in the tensile properties. The tensile stress and modulus of the films can decrease with glycerol content because glycerol can plasticize and ductilize the film matrix. Among three meals, camelina based films can show the highest tensile stress (e.g. 7.5 MPa) and modulus (e.g. 433 MPa) with 5% glycerol.

TABLE 18
Effect of glycerol on tensile properties of canola films at pH 12.

| | Tensile | Tensile | Young's | Moisture |
|---|---|---|---|---|
| Glycerol | stress | strain | modulus | content |
| content | (MPa) * | (%) * | (MPa) * | (%) |
| 5% | 5.67 (5.20) | 5.25 (13.32) | 265 (11.03) | 18.75 |
| 7.5% | 4.84 (15.08) | 5.87 (12.60) | 231 (19.45) | 19.63 |
| 10% | 2.82 (9.18) | 7.68 (20.69) | 96 (22.01) | 20.24 |
| 15% | 2.58 (4.88) | 8.42 (10.18) | 88 (11.83) | 22.77 |

* numbers in parentheses indicate CV %

TABLE 19
Effect of glycerol on tensile properties of camelina films at pH 8.

| | Tensile | Tensile | Young's | Moisture |
|---|---|---|---|---|
| Glycerol | stress | strain | modulus | content |
| content | (MPa) * | (%) * | (MPa) * | (%) |
| 5% | 7.51 (6.16) | 4.24 (15.20) | 433 (11.35) | 13.46 |
| 7.5% | 6.76 (5.45) | 6.13 (11.08) | 287 (8.14) | 13.65 |
| 10% | 3.94 (8.18) | 12.50 (8.96) | 115 (8.75) | 15.03 |
| 15% | 3.63 (6.16) | 12.30 (3.54) | 81 (15.11) | 17.85 |

* numbers in parentheses indicate CV %

TABLE 20
Effect of glutaraldehyde (GA) and glyoxal (GO) on tensile properties
of camelina films containing 7.5% glycerol at pH 8.

| | Tensile | Tensile | Young's | Moisture |
|---|---|---|---|---|
| | stress | strain | modulus | content |
| | (MPa) * | (%) * | (MPa) * | (%) |
| Control | 6.76 (5.45) | 6.13 (11.08) | 287 (8.14) | 13.65 |
| 2.5% GA | 5.13 (4.42) | 8.30 (10.36) | 165 (10.25) | 14.54 |
| 5.0% GA | 5.26 (6.26) | 8.40 (6.56) | 164 (7.34) | 14.18 |
| 7.5% GA | 5.58 (4.93) | 9.24 (10.98) | 162 (5.11) | 14.38 |
| 10.0% GA | 5.47 (10.36) | 9.74 (9.45) | 154 (7.81) | 14.42 |
| 2.5% GO | 6.78 (3.88) | 12.64 (5.49) | 155 (9.75) | 14.29 |
| 5.0% GO | 7.55 (8.03) | 12.13 (8.92) | 171 (8.78) | 13.85 |
| 7.5% GO | 7.03 (6.34) | 10.58 (14.81) | 161 (5.31) | 14.19 |
| 10.0% GO | 7.64 (8.78) | 13.52 (18.99) | 161 (9.26) | 14.43 |

* numbers in parentheses indicate CV %

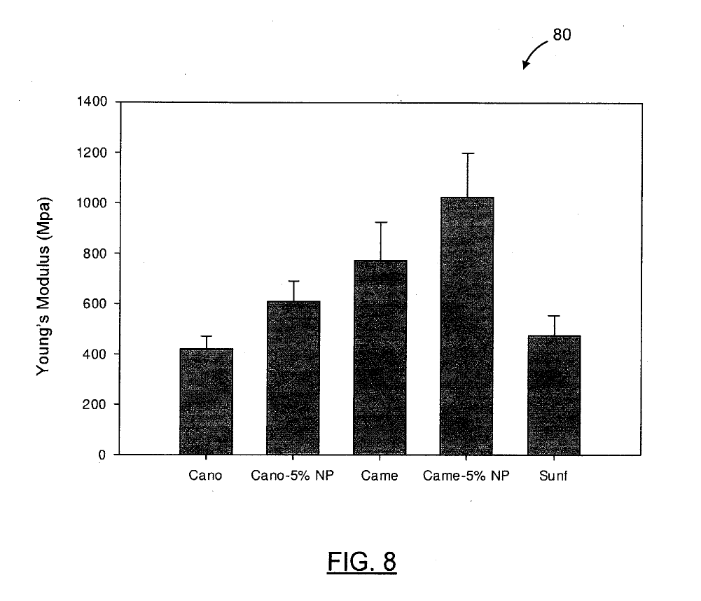

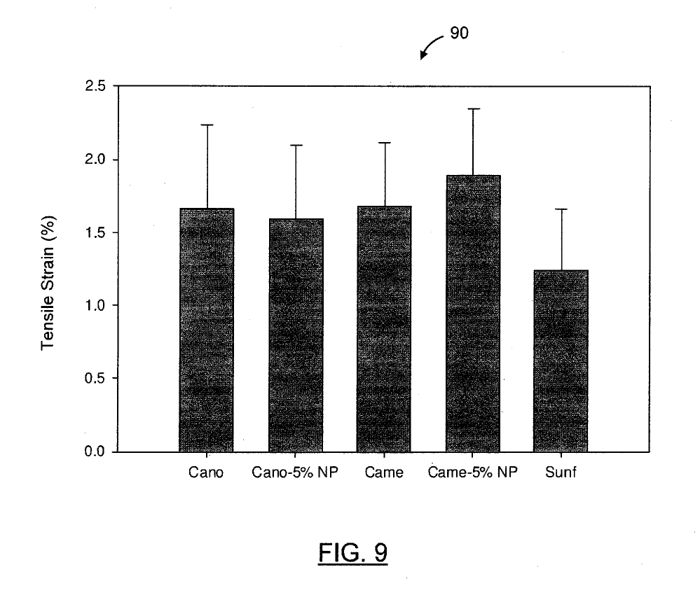

Tensile properties of extruded strands of covering can increase with the addition of newspaper fibers, as illustrated by FIGS. 7-9. The chart 70 of FIG. 7 illustrates the tensile stress, in Megapascals, of the strands of the covering, according to embodiments of the invention using canola, camelina, and sun flower, with 5% newspaper fibers and/or without the newspaper fibers. In the chart 70, the tensile stress was higher for the strands of each type of covering comprising newspaper fiber than for the strands of the same type of covering not comprising newspaper fiber. The chart 80 of FIG. 8 illustrates the Young's modulus, in Megapascals, of strands of the covering, according to embodiments of the invention using canola, camelina, and sun flower, with 5% newspaper fibers and/or without the newspaper fibers. As seen in the chart 80, the Young's modulus was higher for the strands of each type of covering comprising newspaper fiber than for the strands of the same type of covering not comprising newspaper fiber. The chart 90 of FIG. 9 illustrates the tensile strain, in percentage, of strands of the covering, according to embodiments of the invention using canola, camelina, and sun flower, with 5% newspaper fibers and/or without the newspaper fibers. Camelina fiber showed highest tensile stress (e.g. 6.8 MPa to 9.6 MPa) and modulus (e.g. 775 MPa to 1022 MPa) while both canola and sun flower fibers showed similar tensile stress (e.g. 2.3 MPa to 4.7 MPa) and modulus (e.g. 420 MPa to 608 MPa) with and without 5% newspaper.

It is contemplated that numerical values, as well as other values that are recited herein are modified by the term “about”, whether expressly stated or inherently derived by the discussion of the present disclosure. As used herein, the term “about” defines the numerical boundaries of the modified values so as to include, but not be limited to, tolerances and values up to, and including the numerical value so modified. That is, numerical values can include the actual value that is expressly stated, as well as other values that are, or can be, the decimal, fractional, or other multiple of the actual value indicated, and/or described in the disclosure.

While the present invention has been described with reference to a number of specific embodiments, it will be understood that the true spirit and scope of the invention should be determined only with respect to claims that can be supported by the present specification. Further, while in numerous cases herein wherein systems, apparatuses, and methods are described as having a certain number of elements, it will be understood that such systems, apparatuses and methods can be practiced with fewer than the mentioned certain number of elements.

What is claimed is:

1. A biodegradable product for erosion control, plant protection, and seed coating comprising:
a plant-based protein product comprising a plant-based protein;
a plant-based fiber product comprising a plant-based fiber;

2. The biodegradable product of claim 1, further comprising:
a plasticizer to modify the water absorptive properties and strength properties of the biodegradable product.

3. The biodegradable product of claim 2, wherein the plasticizer is comprised of one from the group consisting of linseed oil, glycerol, canola oil, vegetable oil, used cooking oil, gums, agar agar, and guar gum.

4. The biodegradable product of claim 1, further comprising a cross-linking agent to cross-link between the proteins of the plant-based protein product.

5. The biodegradable product of claim 4, wherein the cross-linking agent is plant-based and comprised of one from the group consisting of quercetin and rutin.

6. The biodegradable product of claim 1, further comprising water.

7. The biodegradable product of claim 1, further comprising an additive from the group consisting of pesticides, insecticides, fertilizers, bactericides, pest deterrents, seeds, bioremediation organisms, beneficial organisms, herbicides, fungicides, plant growth regulators, sodium hydroxide, acidity modifiers, clay, nanoclay, surfactants, p-tertiary-octylphenoxy polyethyl alcohol, and water absorbing agents.

8. The biodegradable product of claim 1, mixed dry and configured to be mixed with water to be applied through an applicator to form a geotechnical covering.

9. The biodegradable product of claim 1, wherein the plant-based fiber product comprises between 5% and 80% of the biodegradable product, and the plant-based protein product comprises between 5% and 80% of the biodegradable product.

10. The biodegradable product of claim 1, wherein the plant-based protein product is comprised of one from the group consisting of soy flour, soy meal, canola flour, canola meal, camelina flour, camelina meal, whey, cotton, soy-protein concentrate, soy-protein isolate, corn flour, rice flour, wheat flour, defatted canola, defatted camelina, defatted sunflower, seed-based meals, and bean-based meals.

11. The biodegradable product of claim 1, wherein the plant-based fiber product is one from the group consisting of cellulose, wood pulp, poly lactic acid fibers, recycled newspapers, recycled paper products, recycled cotton products, jute, sisal, kenaf, flax, and hemp.

12. The biodegradable product of claim 1 prepared as one from the group consisting of a solution, a slurry, a resin, and a dough.

13. A biodegradable covering for erosion control, plant protection, and seed coating comprising:
a porous matrix of a dried premixture, the premixture comprising a plant-based protein product, and a plant-based fiber product.

14. The biodegradable covering of claim 13, wherein the covering substantially biodegrades within a predetermined amount of time no longer than six months after the useful life of the covering, and wherein the covering releases natural fertilizing nutrients during biodegradation.

15. The biodegradable covering of claim 13, wherein the biodegradable covering substantially biodegrades in no more than one year.

16. The biodegradable covering of claim 13, further comprising a plasticizer.

17. The biodegradable covering of claim 16, wherein the plasticizer is comprised of one from the group consisting of linseed oil, glycerol, canola oil, vegetable oil, used cooking oil, gums, agar agar, and guar gum.

18. The biodegradable covering of claim 13, further comprising an additive from the group consisting of pesticides, insecticides, fertilizers, bactericides, pest deterrents, seeds, bioremediation organisms, beneficial organisms, herbicides, fungicides, plant growth regulators, sodium hydroxide, acidity modifiers, clay, nanoclay, surfactants, p-tertiary-octylphenoxy polyethyl alcohol, and water absorbing agents.

19. The biodegradable covering of claim 13, applied as a wet premixture and dried.

20. The biodegradable covering of claim 13, wherein the plant-based protein product is comprised of one from the group consisting of soy flour, soy meal, canola flour, canola meal, camelina flour, camelina meal, whey, cotton, soy-protein concentrate, soy-protein isolate, corn flour, rice flour, wheat flour, defatted canola, defatted camelina, defatted sunflower, seed-based meals, and bean-based meals, cotton.

21. The biodegradable product of claim 13, wherein the plant-based fiber product is one from the group consisting of cellulose, wood pulp, poly lactic acid fibers, recycled newspapers, recycled paper products, recycled cotton products, jute, sisal, kenaf, flax, and hemp.

22. The biodegradable product of claim 13, further comprising a cross-linking agent to cross-link between the proteins of the plant-based protein product.

23. The biodegradable product of claim 22, wherein the cross-linking agent is plant-based and comprised of one from the group consisting of quercetin and rutin.

24. A method of forming a biodegradable covering for erosion control, the method comprising the steps:
mixing a biodegradable premixture, the biodegradable premixture comprising a plant-derived protein product, a plant-derived fiber product, and water;
placing the biodegradable premixture in an applicator; and
applying the biodegradable premixture.
